(19) United States
(12) Patent Application Publication
(10) Pub. No.: US 2004/0098375 A1
(43) Pub. Date: May 20, 2004

(54) Automatic domain name status monitor

(75) Inventor: George J. DeCarlo III, Vancouver, WA (US)

Correspondence Address: Kolisch Hartwell, P.C., 200 Pacific Building, 520 S.W. Yamhill Street, Portland, OR, 97204, US

(73) Assignee: Dotster, Inc.

(21) Appl. No.: 10/295,198

(22) Filed: Nov. 14, 2002

(51) Int. Cl. G06F 7/00

(52) U.S. Cl. 707/3

(57) ABSTRACT

The present invention provides methods and apparatus for notifying a user when domain names believed to be of interest to the user become available. The present invention may further provide methods and apparatus for offering domain names to users based on known user preferences.

### BACKGROUND OF THE INVENTION

As internet usage continues to expand, ownership of desirable domain names is becoming increasingly important. Domain names must be registered through ICANN-accredited domain name registrars. Typically, domain names are registered by providing the user with a searchable database of currently registered domain names. The user queries the database regarding the status of a desired domain name. The user is then notified as to whether or not the desired domain name is already registered. If the domain name is currently registered or otherwise unavailable, the user will typically select another domain name to query, or will return later and try again. Some domain name registrars allow a user to initiate a watch service that checks the status of a domain name at periodic intervals. Typically, a user must navigate to a separate watch service screen and manually enter each domain name the user would like watched. This requires that the user remember or track all of the domain names searched and then take the time to navigate to a new page and enter all of the names individually.

### SUMMARY OF THE INVENTION

In a first embodiment the present invention provides a method for notifying a user of the availability of domain names. The method may include the steps of monitoring a domain name search performed by a user, creating a user-specific domain name database including at least one domain name searched for by the user during the domain name search, automatically performing periodic checks to determine whether a domain name in the database is available for registration, and notifying the user that the domain name is available.

In another embodiment, the present invention provides a method for delivering tailored domain name offerings to a user. The method may include the steps of collecting data regarding domain name preferences of a user by monitoring domain name searches performed by the user, creating a user profile including domain names of interest to the user based on the data, periodically querying the availability status of domain names in the user profile, notifying the user when a domain name in the user profile become available for registration, and providing the user with means to register the available domain name.

In yet another embodiment, the present invention provides a system for offering available domain names to users. The system may include a network and a domain name registration provider. The domain name registration provider may include a search monitoring routine adapted to monitor domain name availability searches performed by users, a database configured to store the domain names identified by the search monitoring routine, a search routine adapted to automatically query the availability of the domain names, and a notification routine adapted to automatically notify the user when one or more of the domain names becomes available.

The advantages of the present invention will be understood more readily after a consideration of the drawings and the Detailed Description.

### BRIEF DESCRIPTION OF THE DRAWINGS

FIG. 1 is a flowchart depicting a first embodiment of the present invention.

FIG. 2 is a flowchart depicting the method of FIG. 1 including steps involving user accounts.

FIG. 3 is a flowchart depicting the method of FIG. 1 including steps involving an opt-out option.

FIG. 4 is a flowchart depicting the method of FIG. 1 including steps involving a modification routine.

FIG. 5 is a flowchart including the steps depicted in FIGS. 1-4.

FIG. 6 is a schematic illustration of apparatus according to an embodiment of the present invention.

FIG. 7 is an exemplary user-interface suitable for use with the present invention.

### DETAILED DESCRIPTION AND BEST MODE OF THE PREFERRED EMBODIMENT

The preferred embodiment provides methods and apparatus for notifying a user when domain names believed to be of interest to the user become available. It may further provide methods and apparatus for offering domain names to users based on known user preferences. Briefly, the method begins when a user interested in registering one or more given domain names generates a domain name search request. The domain name search request is monitored and the domain names searched are stored in a database. The domain name registry is then automatically and periodically queried for the status of the domain names in the database. Once a response is received indicating that one or more of the domain names is available, a notice is generated and sent to the user. The method may include means for the user to register the domain name.

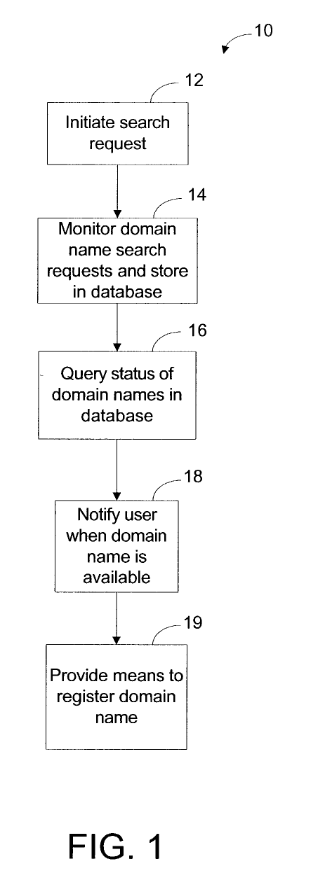

FIG. 1 is a flowchart generally depicting a method 10. As shown at 12, a domain name search request is initiated. In order to generate a domain name search request, a user will typically access a web site administered by an ICANN-accredited domain name registrar. Once at the site, a user may submit a search request including one or more domain names of interest. If a domain name is not currently available for registration, for example if someone else currently owns the registration for the domain name, the user will receive notification of this fact.

At 14, the user's domain name search request is monitored and the domain names that were searched are automatically stored in a database. For the purposes of the present invention, when an action is referred to as being performed automatically, the term “automatically” should be interpreted to mean that the action is performed without the requirement of a user-inputted command. The database may include information such as, but not limited to, the status of each domain name searched, i.e., disabled, unavailable, or available, and the time and date of the search.

At 16, the status of the domain names in the database is then automatically updated at periodic intervals by submitting status queries to the domain name registry. The lag time between queries may be seconds, minutes, hours, days, or any other period of time, as desired. In some cases, the queries may be generated continuously.

At 18, when a previously unavailable domain name becomes available, a notice is generated and forwarded to the user. This notice may be generated automatically. For example, an email message may be automatically generated and sent to the user as soon as the registrar receives notice that a domain name is available.

Finally, as shown at 19, the method may provide means for the user to register the domain name. This may be accomplished by providing means for registering the domain name in the notification. For example, the user may be sent an email message stating that a particular domain name is now available. The email may include a hyperlink that, when activated, allows the user to automatically register the domain name.

Additionally or alternatively, the method may notify the user that a domain name is about to become available. This may occur, for example, because a new top-level domain name is being made available to the public or because a current registration is expiring. In such a case, the method may allow the user to partake in a bidding system, such as that described in coassigned and copending U.S. application Ser. No. 10/161,087 filed May 31, 2002, which is hereby incorporated by reference in its entirety for all purposes.

In one embodiment of the present invention, the database is user specific and maintained as part of a user account. As above, domain name search requests are monitored and a list of the domain names the user searched for is maintained in a temporary database. If the user has a pre-existing account with the registrar, the temporary database is linked to the pre-existing account and maintained permanently. If the user does not have an account, the user may be asked if he or she would like to create an account, and provided with means to do so. If an account is created, the temporary database is linked to the new account and maintained permanently. If no account is created, the information in the temporary database may be maintained in a general database for statistical or other purposes or discarded, as desired.

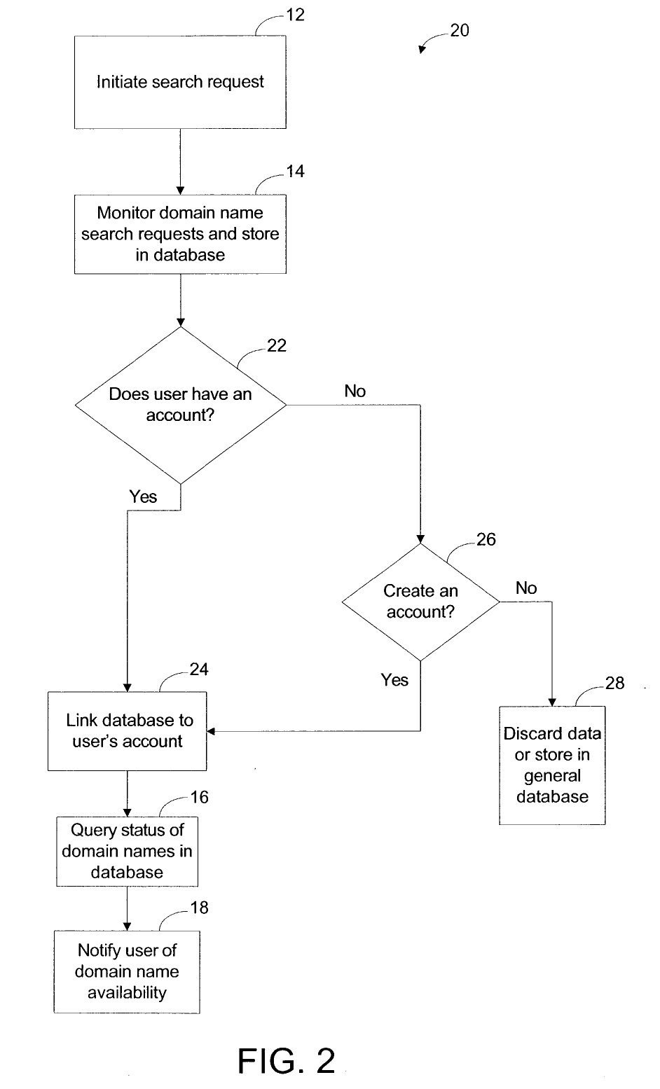

An example of a method 20 employing the creation and maintenance of user accounts is shown in FIG. 2. At 12, a domain name search request is initiated as a domain name registrar's web site. At 14, a domain name search request is monitored and a database is created with the domain names searched. At 22 a query is made regarding whether or not the user has a pre-existing account. If the user has an account, the database containing the domain names searched by the user is linked to the user's account, as shown at 24. If the user does not have an account, the user is asked if he or she would like to create an account, as shown at 26. If the user does not want to create an account, as shown at 28, the data maintained in the database may be discarded or saved in a general database as described above. If the user chooses to create an account, the database is linked to the user's account, as shown at 24. Once the database is linked to the user's account, whether new or preexisting, the status of the domain names in the database is automatically queried at periodic intervals, as shown at 16. At 18, once a response indicating that one or more of the domain names is available is received, the user is notified. The method may provide means for the user to register the domain name, as described above.

It should be appreciated that the method may provide for the determination of whether the user has an account or not to be made at any time during the interaction between the user and the domain name registrar. For example, the registrar may ask the user to log in to an account upon entering the registrar's web site. Alternatively, a user may not be asked for account information until the user initates a domain name search, or tries to leave the site.

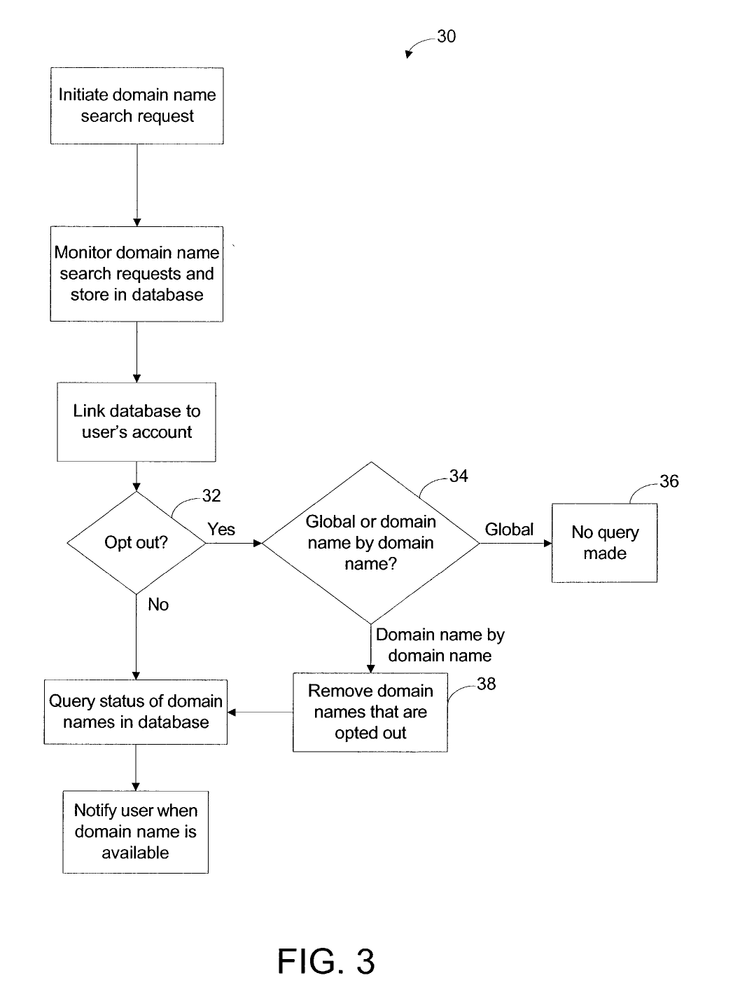

The method may further provide means for the user to opt out of the automatic watch service, even if the user has a pre-existing account. A method 30 employing an opt-out feature is shown in FIG. 3. As with the embodiments described above, a domain name search request is monitored, a database is created based on the domain names searched, and the database linked to the user's account. At 32, the user is asked if he or she would like to opt out of the automatic query system. At 34, if the user chooses to opt out, the user may be given the option of opting out on a global or domain name by domain name basis.

If the user chooses a global opt out, no domain names are submitted for automatic status querying, as shown at 36. The list of domain names searched that has been maintained in the temporary database may be discarded or saved in a general database as described above. Alternatively, any or all of the domain names may be saved in the user-specific database, identified as domain names not to be queried, and withheld from submission for further status querying unless and until the user later indicates a desire to add those domain names to the automatic query system. The storing of the domain names may be performed automatically, or may be presented as an option to the user.

As stated above, the user may select specific domain names to opt out of the automatic search. The domain names the user opts out of are removed from the search, as shown at 38. As a non-limiting example, the user may be presented with a list of previously searched domain names and given the option to select or deselect those domain names the user is no longer interested in pursuing. If the user opts out of some, but not all of the searches, those domain names that have not been removed from the search list are automatically queried at periodic intervals and the user is notified when a domain name becomes available.

It will be appreciated that the default in the above-described invention is that domain names that the user has searched will be automatically queried unless the user opts out. It should be understood, however, that the invention could be set up such that the user selects those domain names that the user would like to have automatically queried (i.e., so that the user must opt in to the automatic search).

As described above, in some embodiments of the present invention, all search requests by a user are monitored and stored in a database. The present invention may further provide for the creation of a user profile based on the user's past behavior. This profile may then be used to suggest and maintain domain names that the user might like to register based on past searches. For example, a particular user may have performed a search to see if john.com and john.info were available for registration. The user profile may then indicate that the user may be interested in any john.xxx domain name where xxx is a top-level domain (i.e., .com, org, net, etc.) Therefore, all possible john.xxx domain names may be submitted for periodic status querying and the user notified when any john.xxx domain name becomes available. Moreover, if a new top-level domain name is introduced and made available to the public, the user likewise may be notified.

As will be appreciated, the preferred embodiment may further allow for the user to modify his or her profile. In this case, the user may be able to access his or her profile and add or delete different domain names or other attributes in order to create a domain name search profile that most accurately reflects the user's interests. According to the present invention, the domain names in the user's profile may then be submitted to the domain name registry for status information.

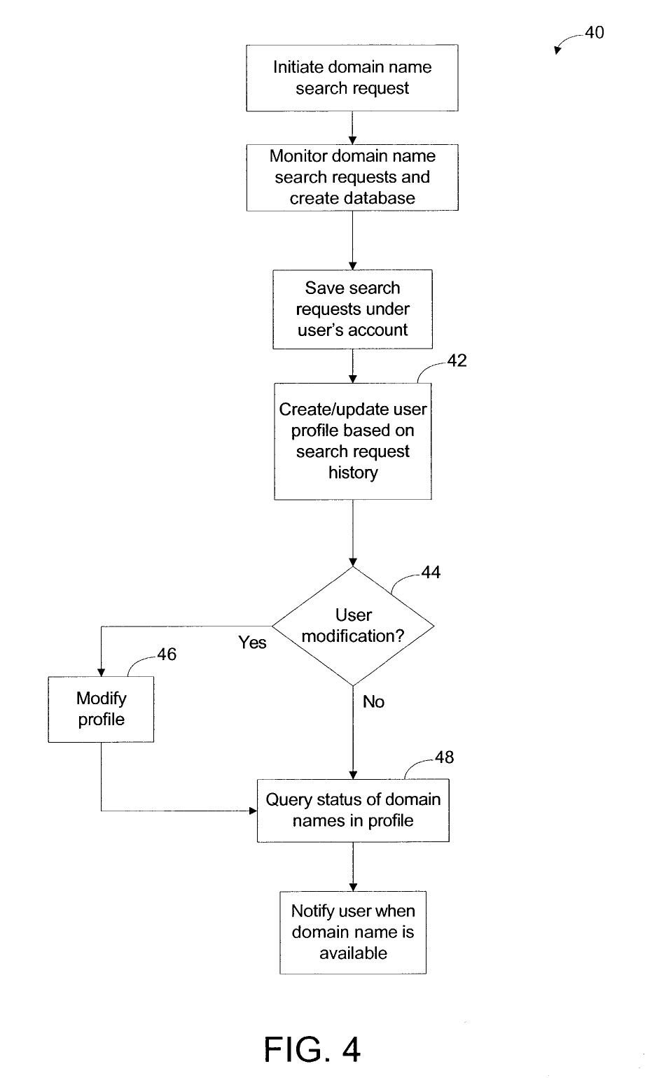

FIG. 4 is a flowchart depicting a method 40 according to an embodiment of the present invention employing a modifiable user profile. As with the embodiments described above, a domain name search request is monitored, a database is created based on the domain names searched, and the database linked to the user's account. At 42, a user-specific search profile is created or updated based on the user's saved search requests. As will be appreciated, each time the user performs a new search, the profile is updated to reflect this new data. At 44, the user may choose to modify his or her profile. At 46, the user makes any desired modifications to the profile. As shown at 48, domain names in the profile are automatically queried at periodic intervals. The user is notified when a domain name becomes available. Again, the method may provide means for the user to register the domain name.

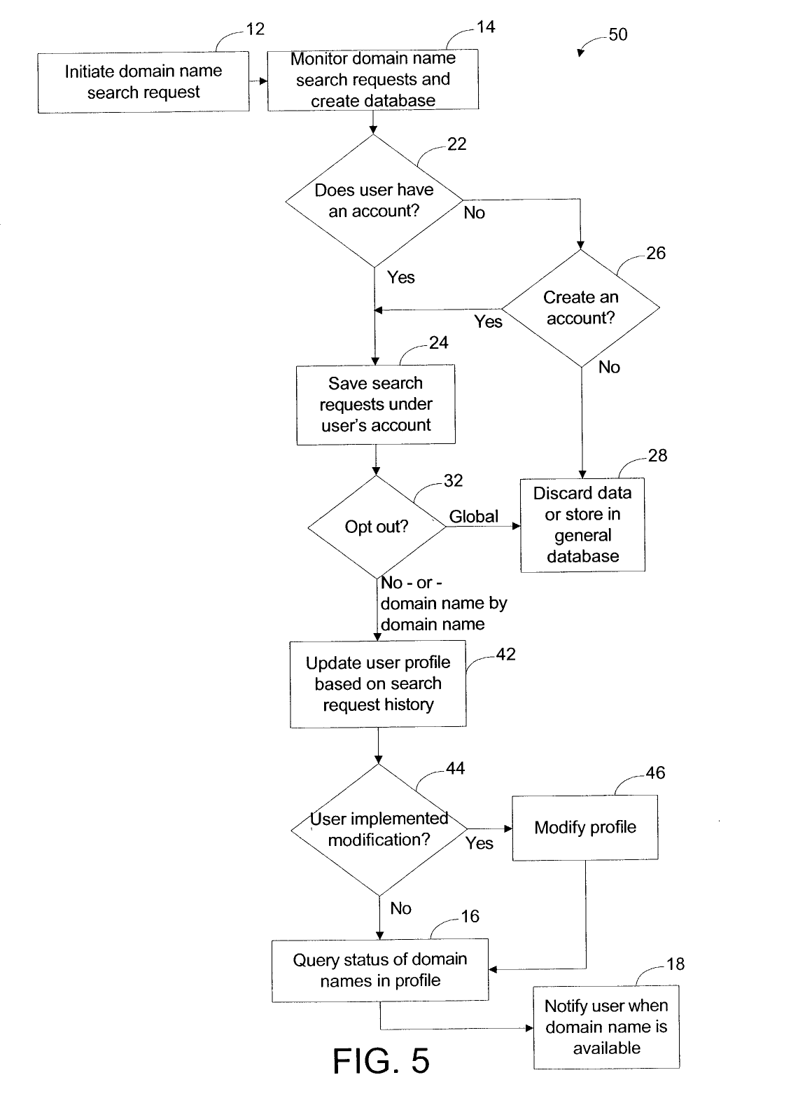

FIG. 5 is a flowchart depicting an embodiment of the present invention including all the options described in FIGS. 1-4. As shown at 12, a domain name search request is initiated. At 14, the domain name search request is monitored and a database is created based on the domain names searched. At 22, it is determined whether or not the user has an account. If the user does not have an account, at 26 the user is asked if he or she would like to create one. If the user responds negatively, the domain names searched may be discarded or saved in a general database, as shown at 28. If the user responds affirmatively, an account is created and the domain names requested by the user are saved in a user-specific database, as shown at 24. If the user already has an account the domain names requested by the user are saved in a user-specific database. At 32, the user is allowed to opt out of the automatic search, if desired.

As shown at 42, a user profile is created based on the domain names in the user-specific database. This user profile may then be modified at 44. These modifications may include changes made by the user (i.e., manual changes to the user-profile or exercise of the opt-out option) and modifications made by the user profile routine.

At 16, the status of the domain names in the user profile is automatically queried at periodic intervals as part of a watch service. At 18, once the watch service receives a response indicating that one or more of the domain names is available, the user is notified. Finally, as shown at 19, the method may provide means for the user to register the domain name.

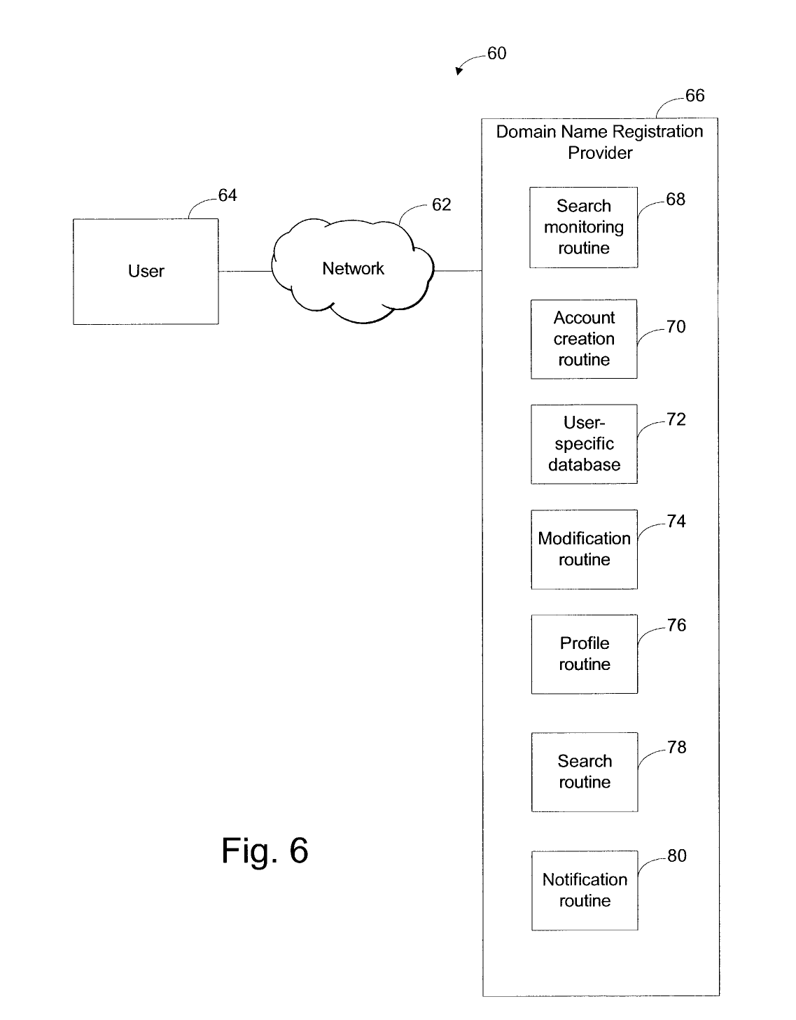

FIG. 6 depicts a system 60 according to another embodiment of the present invention. As shown, system 60 includes a network 62, which may connect a user 64 to a domain name registration provider 66. The domain name registration provider 66 may include one or more computer code routines that may be executed by one or more processors. These routines may include a search monitoring routine 68, an account creation routine 70, a user-specific database 72, an account modification routine 74, a user profile routine 76, a search routine 78, and a notification routine 80. For the sake of clarity, these routines and any subroutines are described as separate routines based on function. However, it should be appreciated that one or more of these routines may be combined into a single routine, divided into additional routines, or arranged in any convenient manner in order to perform the desired function.

Search monitoring routine 68 is responsible for monitoring domain name availability searches performed by users on the domain name registrar's web site. As stated above, a user who wishes to determine whether a particular domain name is available for registration may access a domain name registrar, typically through a web site on the Internet. Typically, domain name registrar web sites provide means by which a user can request that an availability search be performed for a given domain name. Generally, the user submits the desired domain name to the registrar and the registrar then queries the domain name registry to determine the status of the desired domain name. Search monitoring routine 68 may grab the domain names submitted by the user during an interactive session and store the domain names, for example, in user-specific database 72.

Account creation routine 70 is responsible for creating user-specific accounts. These accounts are used to identify a user with user-specific data. The account creation routine typically involves the creation of a distinct user name and password combination for each user. The user name and password are then associated with any user-specific database 72, which may include the user's name, address, and billing information. User specific database 72 also may include domain names the user has registered through the domain name registry and domain name availability requests, as collected by search monitoring routine 68.

Account modification routine 74 provides the user with the ability to make changes to user-specific database 72. Typically account modification routine 74 includes a user interface. The user interface may take the form of a web page having various spaces available for user input. These user inputs may enable the user to change personal account information, opt out of the automatic searching function, or add or delete domain names from the automatic searching function.

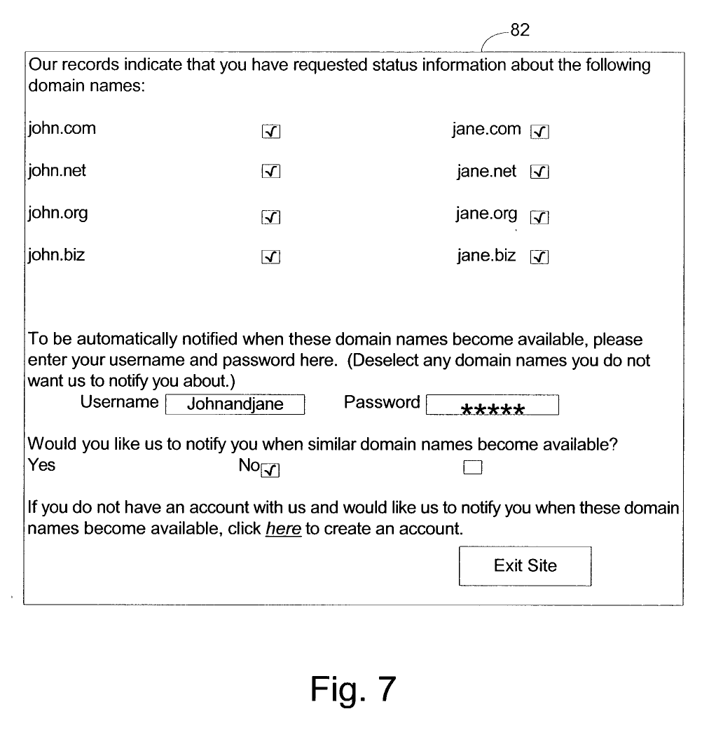

FIG. 7 depicts an exemplary user interface 80 according to another embodiment of the present invention. The user interface shown in FIG. 7 is an example of the type of interface with which a user might be provided when leaving a domain registrar's web site. For example, this user interface may be provided in the form of a pop-up window. As shown, user interface 80 may include a list of domain names that the user has requested status information about. User interface 80 may then allow the user to deselect any domain names the user is not interested in receiving automatic updated information about. The user interface shown in FIG. 7 provides the user with the opportunity to enter user name and password information if the user has not already logged into his or her account. Moreover, user interface 80 allows the user to select whether he or she would like to be notified when similar domain names become available. Finally, user interface 80 provides a link to an account creation web page. As will be appreciated, the above example is to be considered non-limiting. The user interface may be designed to look and function in any suitable manner and may include more or less information than that depicted in FIG. 7.

Returning to FIG. 6, user profile routine 76 is responsible for creating a user profile based on the information in user-specific database 72. User profile routine 76 may be adapted to predict domain names that a user may be interested in registering based on domain names that have been registered and/or searched for by the user in the past.

Search routine 78 is responsible for automatically submitting the domain names in the user profile to the domain name registry to determine if the domain names are available. Searches are typically performed periodically without requiring user prompting or input. Searches may be performed as frequently as desired.

Notification routine 80 is responsible for notifying the user that a domain name in the user's profile is available for registration. This notification may take place by the automatic generation of an email notice. The notification may also include means by which the user can register the domain name. For example, an email notice may include a link which, when activated, automatically registers the domain name to the user.

It should be appreciated that not all of the above functions need be performed automatically, or by a computer. For example, as already previously described, the method may include notifying the user when a domain name becomes available. This may be performed through personal contact, rather than through an automated computer process.

The subject matter of the inventions includes all novel and non-obvious combinations and subcombinations of the various elements, features, functions and/or properties disclosed herein. Similarly, where the disclosure recites “a” or “a first” element or the equivalent thereof, such claims should be understood to include incorporation of one or more such elements, neither requiring nor excluding two or more such elements.

What is claimed is:

1. A method for notifying a user of the availability of domain names, the method comprising:
monitoring a domain name search performed by a user;
creating a user-specific domain name database including at least one domain name searched for by the user during the domain name search;
automatically performing periodic checks to determine whether a domain name in the database is available for registration; and
notifying the user that the domain name is available.

2. The method of claim 1, further comprising the step of providing means to allow the user to register the domain name.

3. The method of claim 1 further comprising the step of linking the user-specific database to a user account.

4. The method of claim 1 further comprising the step of providing the user with the ability to opt out of the periodic checks for at least one domain name.

5. The method of claim 1 further comprising the step of creating a user profile based on the domain name search.

6. The method of claim 5 further comprising the step of modifying the user profile to include domain names believed to be of interest to the user.

7. A method for delivering tailored domain name offerings to a user, the method comprising:
collecting data regarding domain name preferences of a user by monitoring domain name searches performed by the user;
creating a user profile including domain names of interest to the user based on the data;
periodically querying the availability status of domain names in the user profile;
notifying the user when a domain name in the user profile becomes available for registration; and
providing the user with means to register the available domain name.

8. The method of claim 7, further comprising the step of providing the user with the ability to opt out of the step of periodically querying the availability status.

9. The method of claim 7 further comprising the step of modifying the user profile to include domain names believed to be of interest to the user.

10. A system for offering available domain names to users, the system comprising:
a network; and
a domain name registration provider including:
a search monitoring routine adapted to monitor domain name availability searches performed by users;
a database configured to store the domain names identified by the search monitoring routine;
a search routine adapted to automatically query the availability of the domain names; and
a notification routine adapted to automatically notify the user when one or more of the domain names becomes available.

11. The apparatus of claim 10, wherein the domain name registration provider further comprises an account creation routing configured to provide the user with a user name and a password, wherein the user name and password are associated with user-specific information.

12. The apparatus of claim 10, wherein the domain name registration provider further comprises a profile routine adapted to create a user profile based on the domain name availability searches performed by the user.

13. The apparatus of claim 12, wherein the domain name registration provided further comprises a modification routine adapted to modify the profile routine.

14. The apparatus of claim 13 wherein the modification routine is adapted to modify the profile routine by receiving input from the user.

15. The apparatus of claim 14 wherein the input from the user indicates those domain names the user does not want automatically searched.
